(19) United States
(12) Patent Application Publication
(10) Pub. No.: US 2023/0319698 A1
(43) Pub. Date: Oct. 5, 2023

(54) GATEWAY APPARATUS, NETWORK CONTROL APPARATUS, METHOD, PROGRAM AND SYSTEM

(71) Applicant: NIPPON TELEGRAPH AND TELEPHONE CORPORATION, Tokyo (JP)

(72) Inventors: Takayuki NAKAMURA, Tokyo (JP); Shunsuke HOMMA, Tokyo (JP); Mitsuo AMASAKA, Tokyo (JP); Takuya SATO, Tokyo (JP)

(21) Appl. No.: 18/042,879

(22) PCT Filed: Aug. 27, 2020
(86) PCT No.: PCT/JP2020/032484

§ 371 Date: Feb. 24, 2023

(51) Int. Cl. H04W 48/18; H04W 40/12

(52) U.S. Cl. CPC H04W 48/18; H04W 40/12; H04W 88/16

(57) ABSTRACT

A gateway device includes a memory and a processor configured to execute: referring to a transfer table for determining a transfer destination tunnel of a packet upon reception of the packet provided with a header including a slice requirement indicating a packet transfer requirement and a transmission destination domain ID indicating a domain of a transmission destination of the packet, to specify a tunnel corresponding to the slice requirement and the transmission destination domain ID; and outputting the packet to the tunnel specified by the referring.

### TECHNICAL FIELD

The present invention relates to a gateway device, a network control device, a method, a program, and a system.

### BACKGROUND ART

In recent years, the fifth generation mobile communication system (5G: 5th Generation) has been put into practical use. In the 5G era, it is expected to create new services by collaboration with various businesses by utilizing 5G features such as large-capacity broadband, mass session connection, and ultra-low latency high quality. In order to realize such new services, a variety of types of networks that meet various service requirements are required. Network slicing technology has been known as the technology for providing a network quickly and flexibly in response to such demands. In network slicing technology, the infrastructure of shared physical equipment is managed as virtually divisible resources, and such resources are freely combined to build a required virtual network (slice).

An E2E (End-to-End) slice that can ensure a certain level of E2E communication quality is required in order to provide a network (also abbreviated as “NW,” hereinafter) that meets the various requirements of a service provider. The E2E slice is not necessarily a closed network within a single NW operator/domain, and may be a NW that spans multiple NW operators/domains. An architecture has been proposed in which a slice gateway (SLG) is deployed at a connection point between NW operators/domains in order to realize such an E2E slice (simply referred to as “slice,” hereinafter) that spans a plurality of NW operators/domains.

For example, a method of realizing a slice by the NW configuration shown in FIG. 1 is known (NPL 1, for example). The NW configuration shown in FIG. 1 includes an access NW, a core NW, and a NW in a DC (data center), and an SLG is arranged at a connection point of each NW. In this case, tunnels of different types shared by a plurality of slices (e.g., types determined by transfer priority, presence/absence of redundancy, etc.) are set between SLGs, and tunnels in each domain are appropriately connected to each other in accordance with the requirements of the slice (that is, a virtual NW between a terminal and a server/VM (Virtual Machine)), to realize the slice.

For example, bandwidth guarantee and high-reliability slices can be realized by connecting tunnels having priority and route redundancy. Specifically, the slices can be realized by connecting the tunnel 1 of the access NW, the tunnel 5 of the core NW, and the tunnel 13 of the NW in the DC, or connecting the tunnel 3 of the access NW, the tunnel 9 of the core NW, and the tunnel 13 of the NW in the DC.

Similarly, for example, bandwidth guarantee and high-reliability slices passing through an NF (network function) such as Firewall can be realized by connecting tunnels having priority and route redundancy through an NF. Specifically, the slices can be realized by connecting the tunnel 1 of the access NW, the tunnel 7 of the core NW, and the tunnel 13 of the NW in the DC, or connecting the tunnel 3 of the access NW, the tunnel 11 of the core NW, and the tunnel 16 of the NW in the DC.

Similarly, for example, BE (best effort) and high-reliability slices can be realized by connecting tunnels having a BE/route redundancy. Specifically, the slices can be realized by connecting the tunnel 2 of the access NW, the tunnel 6 of the core NW, and the tunnel 14 of the NW in the DC, or connecting the tunnel 4 of the access NW, the tunnel 10 of the core NW, and the tunnel 17 of the NW in the DC. BE/low-reliability slices or the like can also be realized by properly connecting tunnels to each other in the same way. For example, an application is mounted on a terminal, and various services are provided to the terminal by application processing executed by the server/VM.

In the method described in NPL 1, information indicating transfer requirements such as the transfer priority of a packet and the necessity of route redundancy that are required for satisfying the service requirements, the ID of the edge SLG to be the ground, and information uniquely indicating a slice for NW separation are given to the header of the packet to realize a slice. The edge SLG is an edge arranged at the edge of the domain, and SLG other than the edge SLG is called a relay SLG. The edge SLG to be the ground is the edge SLG to be the packet transmission destination.

### CITATION LIST

### Non Patent Literature

[NPL 1] Nakamura, et al., “Proposal of D-Plane configuration system for efficient E2E network slicing,” Research papers from IEICE General Conference 2020.

### [NPL 2] Z. Li and P. Mohapatra, “QRON: QoS-AWare Routing in Overlay Networks,” IEEE Journal on Selected Areas in Communication, Vol. 22, No. 1, pp. 29-40, January 2004.

[NPL 3] Fujita, et al., “Scalable QoS Routing Scheme in Overlay Network,” Technical research report from IEICE, Volume 107, number 148 IN2007-27.

### SUMMARY OF INVENTION

### Technical Problem

However, since the conventional method described in NPL 1 assumes a simple NW configuration in which domains are linearly connected, if the number of connected domains increases and the NW configuration becomes planarly complicated, the transfer table set in each SLG increases, possibly resulting in an increase in the processing load of the SLG, deterioration of the transfer performance, and the like. The transfer table is a table for determining a packet output destination tunnel.

One embodiment of the present invention was made in view of the issue described above, and an object thereof is to suppress an increase of the transfer table of the SLG for realizing an E2E slice.

### Solution to Problem

In order to achieve the object described above, a gateway device according to an embodiment includes a transfer destination specification unit that refers to a transfer table for determining a transfer destination tunnel of a packet upon reception of the packet provided with a header including a slice requirement indicating a packet transfer requirement and a transmission destination domain ID indicating a domain of a transmission destination of the packet, to specify a tunnel corresponding to the slice requirement and the transmission destination domain ID, and a transfer unit that outputs the packet to the tunnel specified by the transfer destination specification unit.

### Advantageous Effects of Invention

Thus, the increase of the transfer table of the SLG for realizing the E2E slice can be suppressed.

### BRIEF DESCRIPTION OF DRAWINGS

FIG. 1 is a diagram showing an example of an NW configuration for realizing a slice.

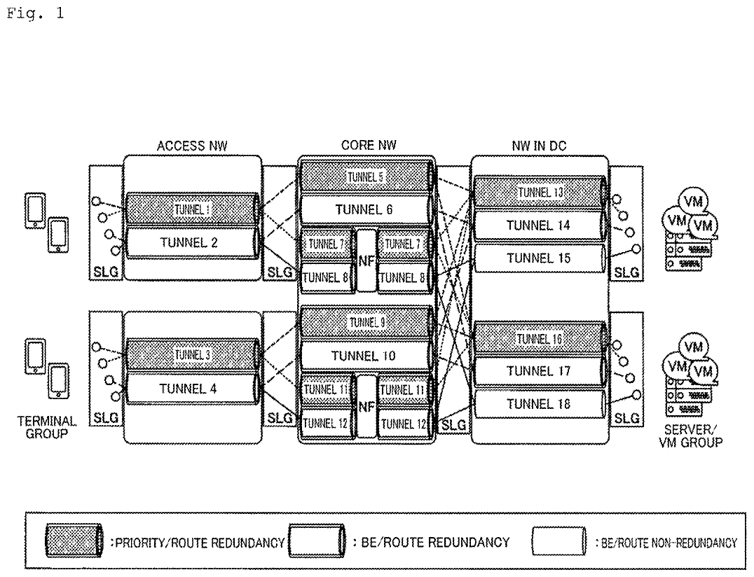

FIG. 2 is a diagram for explaining the outline of the conventional method.

FIG. 3 is a diagram for explaining a transfer table of the conventional method.

FIG. 4 is a diagram for explaining the problems of the conventional method.

FIG. 5 is a diagram for explaining an example of transfer processing according to the present embodiment.

FIG. 6 is a diagram showing an example of a transfer table according to the present embodiment.

FIG. 7 is a diagram for explaining an example of route learning processing according to the present embodiment.

FIG. 8 is a diagram showing an example of an inter-domain connection table according to the present embodiment.

FIG. 9 is a diagram for explaining prevention of the occurrence of a loop in route information.

FIG. 10 is a diagram showing an example of functional configurations of an NW controller and an SLG according to the present embodiment.

FIG. 11 is a diagram showing an example of a hardware configuration of the NW controller according to the present embodiment.

FIG. 12 is a diagram showing an example of hardware configurations of an edge SLG and a relay SLG according to the present embodiment.

### DESCRIPTION OF EMBODIMENTS

Hereinafter, an embodiment of the present invention will be described.

### Outline of Conventional Method

First, before explaining an embodiment of the present invention, an outline of realizing a slice by the method described in NPL 1 (referred to as “conventional method,” hereinafter) and a problem thereof will be described.

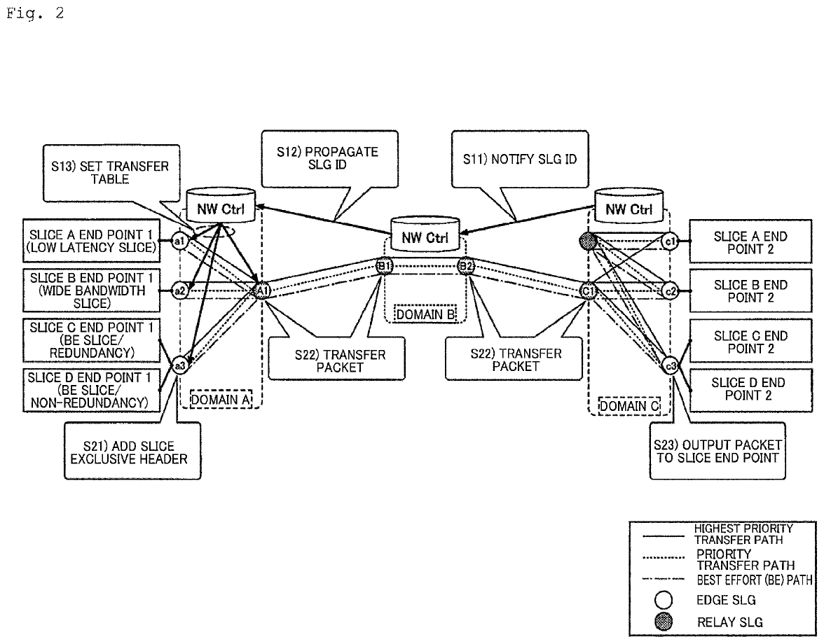

The case where there exist three domains, i.e., a domain A, a domain B, and a domain C as shown in FIG. 2, will be described as an example. An NW controller (described as “NW Ctrl” in FIG. 2) and an SGL are arranged in each domain. In FIG. 2 “a1” to “a3,” “c1” to “c3,” “A1,” “B1,” “B2,” and “C1” indicate SLG IDs. Note that the NW controller is an instrument, a device, a program or the like that manages various settings (including transfer tables) of NW instruments such as SLGs.

Also, for example, a terminal, a server/VM, and application processing and the like executed by them are represented as slice end points. In the example shown in FIG. 2, there are four slice end points, i.e., a slice A end point to a slice D end point, and the transfer requirements thereof are, respectively, “low latency,” “wide band,” “BE (best effort)/with redundancy,” and “BE/non-redundancy.”

Further, a tunnel ID of a tunnel between SLGs is expressed in the form of “SLG ID-1 to 3 of SLG ID of SLG on the left side+SIG ID of SLG on the right side,” a tail “1” represents the highest priority transfer path, a tail “2” the priority transfer path, and a tail “3” a BE path. For example, three tunnels exist between an edge SLG of SLG ID “a1” and a relay SLG of SLG ID “a1.” The tunnel ID of the tunnel which is the highest priority transfer path is expressed as “a1A1-1,” the tunnel ID of the tunnel which is the priority transfer path as “a1A1-2,” and the tunnel ID of the tunnel which is the BE path as “a1A1-3.”

In this case, in the conventional method, route learning processing for learning a route by cooperation between NW controllers and setting a transfer table to each SLG, and transfer processing for transferring a packet by the transfer table set to each SLG are executed. An example of the route learning processing will be described hereinafter using S11 to S13, and an example of the transfer processing will be described using S21 to S23.

S11) The NW controller of each domain notifies the NW controller of an adjacent domain, of the SLG ID of the edge SLG arranged in its own domain. In the example shown in FIG. 2, the NW controller of the domain C notifies the NW controller of the domain B, of the SLG IDs “c1” to “c3.”

S12) When the SLG ID is notified from the NW controller of the adjacent domain, each NW controller propagates the SLG ID to the NW controller of an adjacent domain other than said neighboring domain. In the example shown in FIG. 2, the NW controller of the domain B propagates the SLG IDs “c1” to “c3” to the NW controller of the domain A.

S13) When the SLG ID is notified from the NW controller of the adjacent domain, each NW controller sets up a transfer table for transmitting a packet to the edge SLG of the SLG ID, for the SLG arranged in its own domain, based on the SLG ID and the notification source domain. That is, each NW controller sets up a transfer table by associating a tunnel ID of an output destination tunnel for transmitting a packet to the edge SLG of the SLG ID, the SLG ID, transfer priority, presence/absence of redundancy, and the like. In the example shown in FIG. 2, the NW controller of the domain A sets up a transfer table for transmitting a packet to the edge SLGs of the SLG IDs “c1” to “c3,” for the SLG in its own domain.

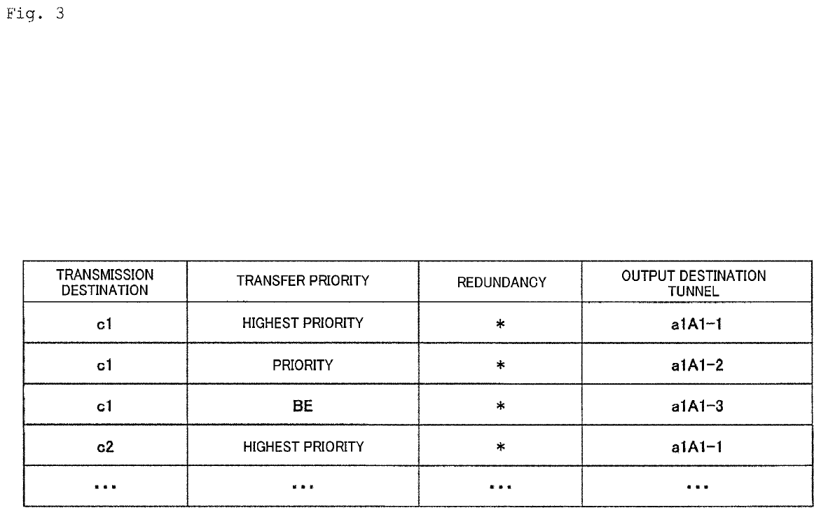

FIG. 3 shows an example of the transfer table set at the edge SLG of the SLG ID “a1.” As shown in FIG. 3, in the transfer table, the SLG ID of the packet transmission destination, the transfer priority, the presence/absence of redundancy, and the tunnel ID of the output destination tunnel are associated with each other. The “* (asterisk)” represents a wild card.

This indicates that, in the transfer table shown in FIG. 3, for example, the SLG ID of the packet transmission destination is “c1,” the transfer priority is “highest priority,” and when the redundancy is “*,” the output destination tunnel is “a1A1-1.” Similarly, for example, when the SLG ID of the packet transmission destination represents “c1,” the transfer priority is “priority,” and when the redundancy is “*,” the output destination tunnel is “a1A1-2.” In addition to the transfer priority and the presence/absence of redundancy, the transfer table may be associated with, for example, whether or not the NF is used.

S21) When a packet is input from a slice end point, the edge SLG of each domain adds a slice exclusive header to the packet. Here, in the conventional method, information indicating transfer requirements such as transfer priority of a packet required for satisfying service requirements and redundancy necessity (i.e., slice requirements), the SLG ID of an edge SLG to be the ground, information uniquely indicating a slice (referred to as “slice ID” or “slice identification information”) are defined as the slice exclusive header.

S22) Each relay SLG of each domain, upon reception of a packet transferred from another relay SLG, refers to a transfer table set in itself, determines an appropriate output destination tunnel from the slice exclusive header of the packet, and transfers the packet.

S23) Upon reception of the packet transferred from the relay SLG, the edge SLG refers to slice identification information included in the slice exclusive header of the packet, deletes this slice exclusive header, and outputs the packet to an appropriate slice end point (i.e., a slice end point corresponding to the slice identification information). Thus, the E2E slice is realized in the conventional system.

However, as described above, the conventional method assumes a simple NW configuration in which domains are linearly connected. Therefore, when the number of connection domains is increased and the NW configuration becomes planarly complicated, the transfer table set for each SLG increases, resulting in an increase in the processing load of the SLG, deterioration of the transfer performance, and the like. For example, as shown in FIG. 3, the case where there exist seven domains, i.e., the domain A to the domain G, will be described. The meanings of the symbols, constituent elements, and the like are the same as those in FIG. 2.

In this case, since each SLG has the transfer table set for each edge SLG as described above, the transfer table increases with an increase in the NW scale such as an increase in the number of connection domains and an increase in the number of SLGs. Therefore, an increase in load of each SLG, deterioration in transfer performance, and the like may occur.

Further, the transfer table needs to be updated by adding or reducing edge SLGs in the existing domains. As the number of connection domains increases, the frequency of such update increases, and the load of the NW controller also increases. For example, when the edge SLG of the SLG ID “g4” is newly provided in the domain G (S31), the NW controller of the domain G advertises (notifies) the SLG ID “g4” to the NW controller of an adjacent domain (i.e., the domain C, the domain D, and the domain F) (S32). Thus, the SLG ID “g4” is propagated to the NW controller of each domain (S33), and the transfer table of each SLG of each domain is updated on the basis of the SLG ID “g4” and the notification source domain (i.e., information for transmitting a packet to the edge SLG of the SLG ID “g4” is added to the transfer table). In this manner, each NW controller needs to perform route learning processing for updating the transfer table each time the edge SLGs are increased or reduced, and the frequency of the route learning processing increases as the number of domains increases, thereby increasing the load of each NW controller.

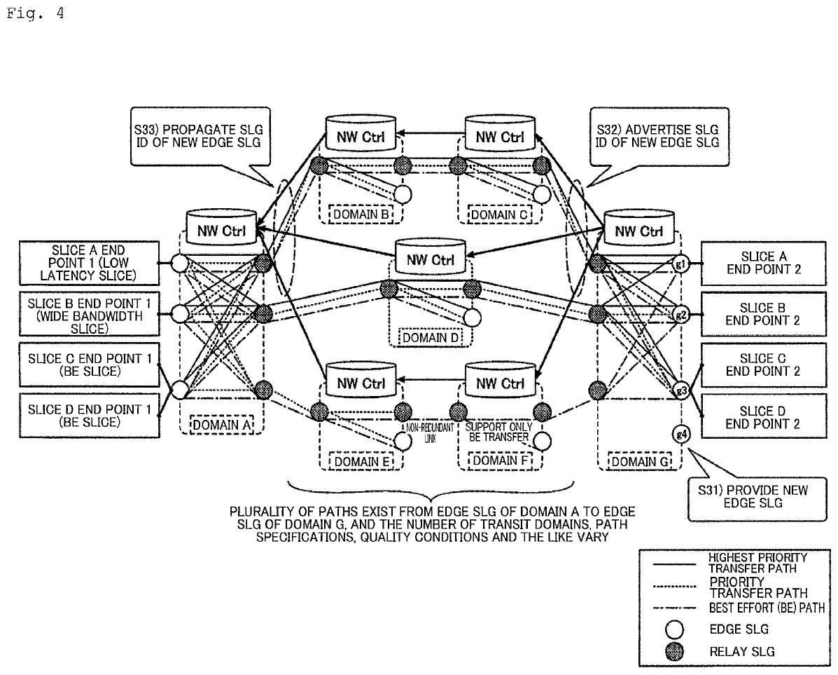

Further, in the conventional method, as described above, the route learning is performed by exchanging the SLG ID of an edge SLG between the NW controllers of the respective domains, but when there are a plurality of routes addressed to the same edge SLG, an optimum route cannot be determined in consideration of the number of transit domains for each route, path specifications (for example, QoS class, presence/absence of redundancy, and the like) and the difference in quality (e.g., bandwidth, latency, or the like). For example, as shown in FIG. 4, there are a plurality of routes from the edge SLG of the domain A to the edge SLG of the domain G, but the number of transit domains, path specifications, quality difference, and the like vary. That is, for example, the number of transit domains varies between a route passing through the domain B and the domain C and a route passing through the domain D. Also, for example, the number of transit domains is the same in the route passing through the domain B and the domain C and a route passing through the domain E and the domain F, but the route passing through the domain B and the domain C is made redundant to support routes of various qualities, whereas the route passing through the domain E and the domain F support only the BE/route non-redundancy, so that the path specifications and quality are different.

Therefore, the conventional problem has (1) the problem that the NW configuration being planarly complicated leads to a load increase in SLGs, deterioration of transfer performance, and a load increase of NW controllers, and (2) the problem that an optimum route cannot be determined in consideration of the number of transit domains, path specifications, quality and the like when there are a plurality of routes addressed to the same edge SLG.

### Route Learning Processing and Transfer Processing according to Present Embodiment

The present embodiment describes the route learning processing and the transfer processing that solving the foregoing two problems, (1) and (2).

### Transfer Processing

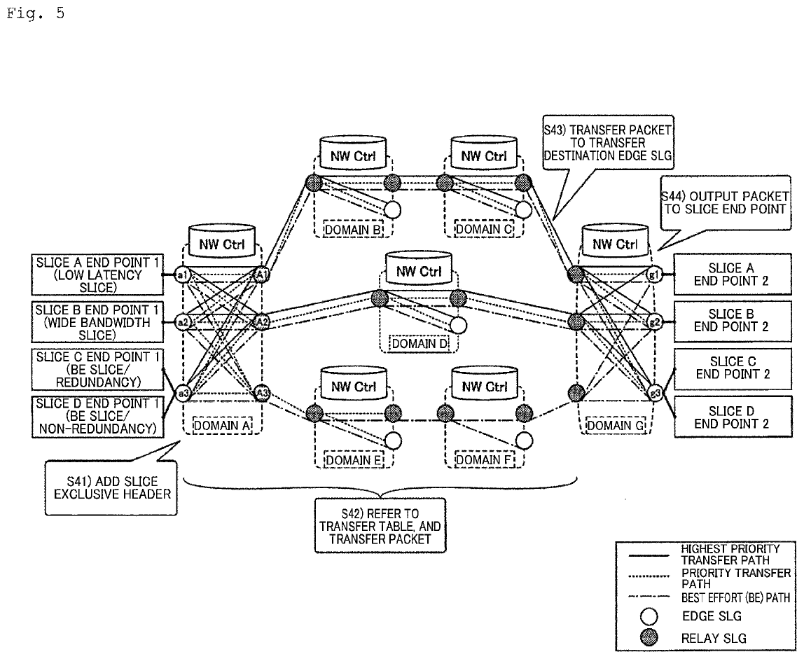

First, an example of the transfer processing according to the present embodiment will be described using S41 to S44 of FIG. 5, assuming that the route learning processing has been executed and the transfer table has been set in each SLG. Note that the meanings of the symbols, constituent components and the like of FIG. 5 are the same as those of FIG. 2.

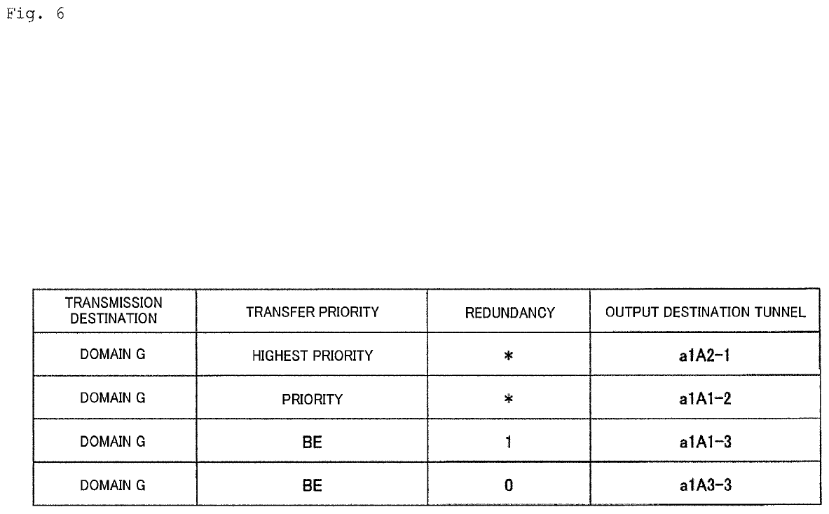

Here, the transfer table according to the present embodiment is associated with information uniquely indicating a domain (referred to as “domain ID,” hereinafter), not with an SLG ID, as a packet transmission destination. As an example, FIG. 6 shows a transfer table set at the edge SLG of the SLG ID “a1.” As shown in FIG. 6, unlike the conventional method, the transfer table according to the present embodiment uses domain IDs instead of SLG IDs. Note that “1” and “0” in redundancy represent redundancy and non-redundancy, respectively.

S41) When a packet is input from a slice end point, the edge SLG of each domain adds a slice exclusive header to the packet. Here, in the present embodiment, information indicating transfer requirements such as a transfer priority of a packet required for satisfying service requirements and redundancy necessity (i.e., slice requirements), the domain ID of the transmission destination domain, and the slice identification information are defined as the slice exclusive header. That is, the slice exclusive header according to the present embodiment uses the domain ID of the transmission destination domain instead of the SLG ID of the edge SLG to be the ground.

S42) Each relay SLG of each domain other than the transmission destination domain refers to the transfer table set in itself upon reception of a packet transferred from another relay SLG, determines an appropriate output destination tunnel from the slice exclusive header of the packet, and transfers the packet.

S43) Upon reception of the packet transferred from said another relay SLG, each relay SLG of the transmission destination domain transfers the packet to the corresponding edge SLG of its own domain on the basis of the slice identification information included in a slice exclusive header of the packet and other information (e.g., a destination IP address included in a header of the packet).

S44) Upon reception of the packet transferred from the relay SLG, the edge SLG refers to slice identification information included in the slice exclusive header of the packet, deletes this slice exclusive header, and outputs the packet to an appropriate slice end point (i.e., a slice end point corresponding to the slice identification information). Accordingly, the E2E slice is realized.

Thus, in the transfer processing according to the present embodiment, packet transfer is performed in which instead of designating the SLG ID as the transmission destination, the domain ID which is a larger unit is designated. For this reason, in the route learning processing described hereinafter, the transfer table specifying the domain ID as the transmission destination is set in each SLG. As a result, the edge SLG in each domain can be concealed, the increase of the transfer table is suppressed, the increase of the load of the SLG and the deterioration of the transfer performance are suppressed, and the increase of the load of the NW controller accompanying the increase/reduction of the edge SLG can be suppressed.

### Route Learning Processing

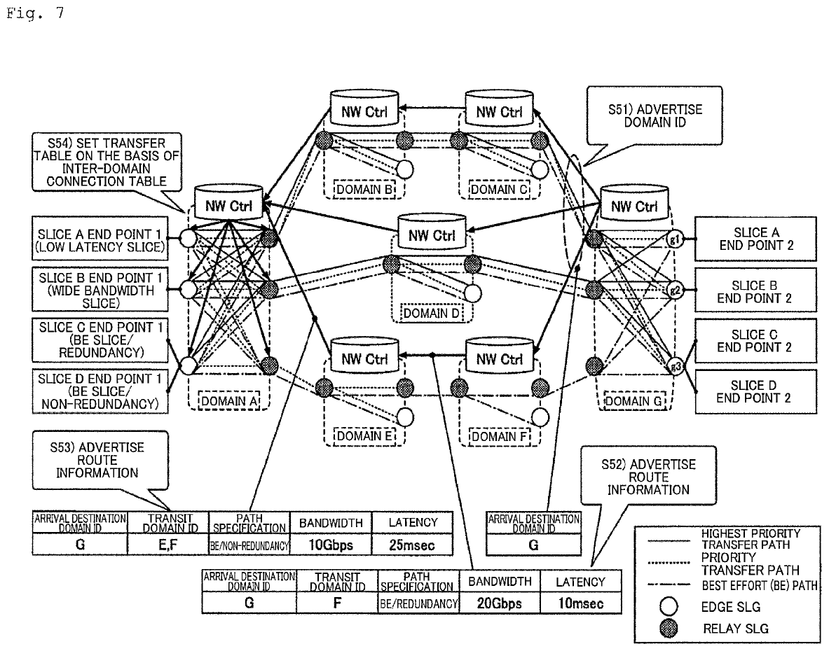

Next, an example of the route learning processing according to the present embodiment will be described using S51 to S54 of FIG. 7. Note that the meanings of the symbols, constituent components and the like of FIG. 7 are the same as those of FIG. 2.

S51) The NW controller of each domain advertises (notifies) the domain ID of the own domain as an arrival destination domain ID, to the NW controller of an adjacent domain. In the example shown in FIG. 7, the NW controller of the domain G advertises the domain ID “G” to the NW controller of the domain C, the NW controller of the domain D, and the NW controller of the domain F. The arrival destination domain ID means a domain ID which is a packet transmission destination.

S52) When the arrival destination domain ID is notified from the NW controller of the adjacent domain, each NW controller advertises the route information to the NW controller of an adjacent domain other than the foregoing adjacent domain. The route information includes the arrival destination domain ID, a transit domain ID indicating a domain ID of the own domain, path specifications supported by a route of a section between a relay SLG of the own domain adjacent to the advertisement destination domain and a relay SLG of a notification source domain of the arrival destination domain ID, and quality information of each path specification (e.g., bandwidth, latency, etc). In the example shown in FIG. 7, the arrival destination domain ID “G,” the transit domain ID “F,” the path specification “BE/redundancy,” the bandwidth “20 Gbps,” and the latency “10 msec” are included in the route information. The path specification, bandwidth, and latency are path specifications and quality (bandwidth and latency) supported by a route of a section between a relay SLG adjacent to the domain E among relay SLGs in the domain F and a relay SLG adjacent to the domain F among relay SLGs in the domain G. The path specifications and quality information for each path specification supported by a certain route are path specifications that can be provided on the route and information on quality for each path specification.

S53) When the route information is notified from the NW controller of the adjacent domain, each NW controller stores the route information in an inter-domain connection table, adds the domain ID of its own domain to the transit domain ID, updates the path specifications and quality information as necessary, and then advertises the route information to the NW controllers of adjacent domains other than the foregoing adjacent domain.

In so doing, the path specifications and the quality information are updated as follows.

(A) When a path specification supported by a route of a section between a relay SLG of its own domain adjacent to the advertisement destination domain and a relay SLG of the notification source domain of the route information is lower, the route information is updated with this low path specification. The low path specification means that the number of types of path specifications supported in said section is small and that there is no redundancy.

(B) When the bandwidth of said section is lower in the corresponding path specification, the route information is updated with this low bandwidth.

(C) In the corresponding path specification, the latency of said section is added to the latency included in the route information.

Specific examples of the above-mentioned (A) to (C) are described. In a case where the path specification included in the notified route information “highest priority/redundancy” and “BE/redundancy,” and the path specification supported by a route of a section between a relay SLG of the own domain adjacent to the advertisement destination domain and a relay SLG of the notification source domain of the route information indicates “Be/redundancy,” the path specification of the route information is updated to “Be/redundancy” (i.e., in this case, “highest priority/redundancy” and its quality information (bandwidth, latency) are deleted from the route information). Alternatively, for example, when the path specification included in the notified route information indicates “highest priority/redundancy” and the path specification supported by a route of a section between a relay SLG of the own domain adjacent to the advertisement destination domain and a relay SLG of the notification source domain of the route information indicates “highest priority/non-redundancy,” the path specification of the route information is updated to “highest priority/non-redundancy.” In (B), for example, when the bandwidth of a certain path specification included in the notified route information is “20 Gbps” and the bandwidth of said path specification in said section is “10 Gbps,” the bandwidth of the path specification included in the route information is updated to “10 Gbps.” In (C), for example, when the latency of a certain path specification included in the notified route information is “10 msec” and the latency of said path specification in said section is “15 msec,” the latency of the path specification included in the route information is updated to “25 msec.”

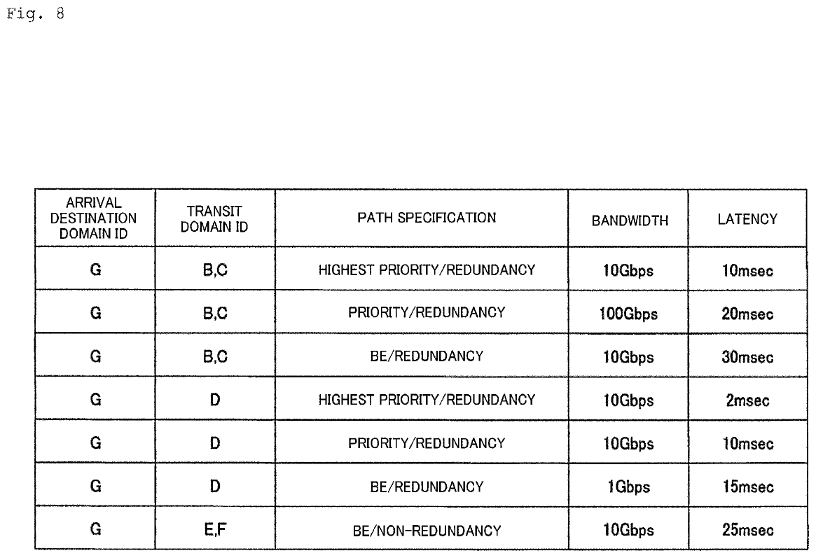

FIG. 8 shows an example of the inter-domain connection table held by the NW controller of the domain A. As shown in FIG. 8, the inter-domain connection table according to the present embodiment is a table in which route information notified from the NW controller of the adjacent domain is stored. Thus, each NW controller manages path specifications and quality information of the transit domain to the arrival destination domain and the route to the arrival destination domain in the inter-domain connection table. Accordingly, a transfer table for selecting an optimum route taking into consideration the number of transit domains, path specifications, and quality information can be set in each SLG.

S54) The NW controller of each domain sets a transfer table for transmitting a packet to each domain ID with respect to the SLG of its own domain on the basis of the inter-domain connection table held in itself. In so doing, the NW controller of each domain selects route information corresponding to transfer requirements to be satisfied by the slice, in consideration of path specifications and quality information of a transit domain to the arrival destination domain and a route to the arrival destination domain, whereby a transfer table is set in each SLG, the transfer table having the arrival destination domain ID of the route information as the transmission destination domain ID, the path specifications as the transfer priority, and the tunnel for transferring a packet to the first transit domain ID as the output destination tunnel. Thus, for each SLG, a transfer table is set to realize a slice in an optimum route taking into consideration the number of transit domains, path specifications, and quality information.

Note that what kind of route information should be selected can be considered in various ways in accordance with the transfer requirements to be satisfied by the slice, and various selection methods can be adopted for each domain. An example of a method of selecting route information will be described hereinafter with reference to the inter-domain connection table shown in FIG. 8.

The slice A shown in FIG. 7 is a “low latency slice.” Therefore, when setting transfer information used when using the slice A (one record in the transfer table), for example, the route information with the least latency (the fourth route information from the top) is selected from among the route information stored in the inter-domain connection table shown in FIG. 8.

The slice B shown in FIG. 7 is a “wide bandwidth slice.” Therefore, when setting transfer information used when using the slice B, for example, the route information with the largest bandwidth (the second route information from the top) is selected from among the route information stored in the inter-domain connection table shown in FIG. 8.

The slice C shown in FIG. 7 is a “BE slice/redundancy.” Therefore, when setting transfer information used when using the slice C, for example, the route information with BE, redundancy, and the largest bandwidth (the third route information from the top) is selected from among the route information stored in the inter-domain connection table shown in FIG. 8.

The slice D shown in FIG. 7 is a “BE slice/non-redundancy.” Therefore, when setting the transfer information used when using the slice D, for example, the route information with BE and no redundancy (the seventh route information from the top) is selected from among the route information stored in the inter-domain connection table shown in FIG. 8.

An example of selecting route information without considering the number of transit domains has been described above, but for example, when selecting route information, route information may be selected so that the number of transit domains is as small as possible, in addition to considering the conditions of path specifications and bandwidths.

In this case, depending on the NW configuration, when advertising the route information in S53 described above, there is a possibility that a loop occurs in the route advertisement between the NW controllers. Thus, in order to prevent the occurrence of a loop, in S53 described above, each NW controller compares the route information to be advertised to an adjacent domain, with the route information already advertised from this adjacent domain to the own domain, and, when the following conditions are satisfied, does not advertise the route information to be advertised to the adjacent domain.

Conditions: In the route information of the same arrival destination domain and the same path specifications, the number of transit domains included in the route information to be advertised to the adjacent domain (including the own domain) is equal to or greater than the number of transit domains included in the route information already advertised from the adjacent domain.

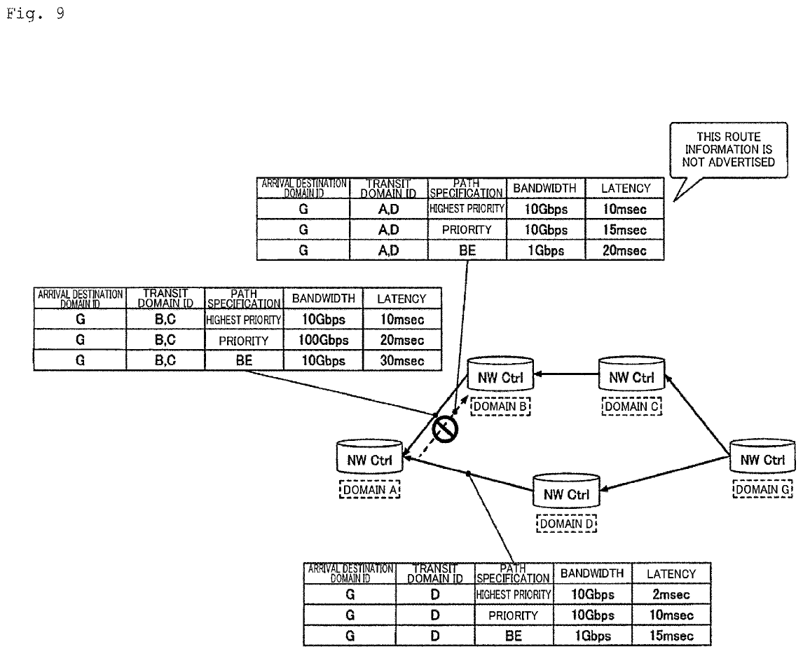

A specific description will be given with reference to FIG. 9. It is assumed that the route information notified from the NW controller of the domain B has already been stored in the inter-domain connection table held by the NW controller of the domain A. In this case, when the route information is notified from the NW controller of the domain D, the NW controller of the domain A does not notify (advertise) the route information to the NW controller of the domain B. This is because, in the route information of the same arrival destination domain and the same path specifications, the number of transit domains included in the route information to be advertised to the domain B that is generated by the NW controller of the domain A based on the route information advertised from the domain D is 2, and the number of transit domains included in the route information already advertised from the NW controller of the domain B is 2, satisfying the conditions described above.

### Functional Configuration

Next, the functional configurations of the NW controller 10 and the SIG (edge SLG 20 and relay SLG 30) according to the present embodiment will be described.

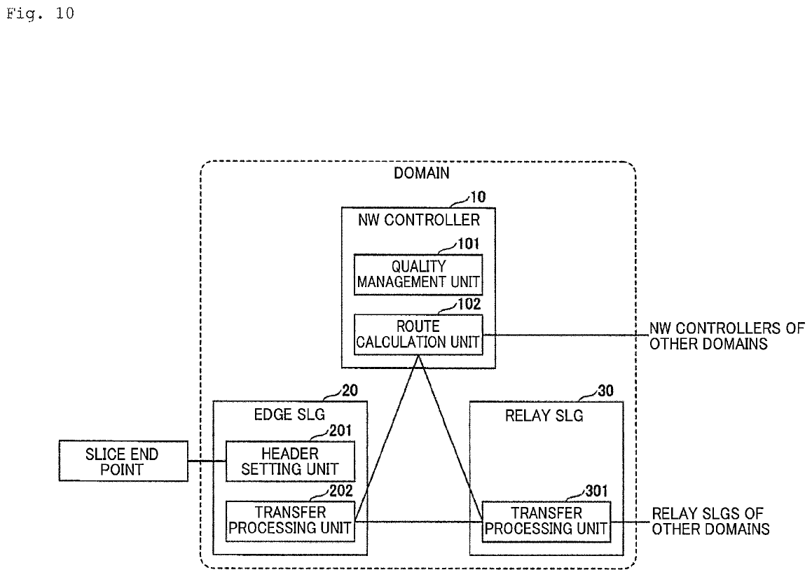

As shown in FIG. 10, the NW controller 10 according to the present embodiment includes a quality management unit 101 and a route calculation unit 102. These function units are realized by hardware such as a processor or a memory device.

The quality management unit 101 holds specifications (transfer priority, presence/absence of redundancy, etc.) of paths between an edge SLG 20 and a relay SLG 30 of the own domain, between a relay SLG 30 and a relay SLG 30, and between a relay SLG 30 of the own domain and a relay SLG 30 of an adjacent domain, and quality information for each of the paths (available bandwidths, latency, etc.).

The route calculation unit 102 advertises the domain ID of the own domain to an adjacent domain as an arrival destination domain ID.

When the arrival destination domain ID is advertised (notified) from the NW controller 10 of an adjacent domain, the route calculation unit 102 advertises route information including this arrival destination domain ID to the NW controller 10 of an adjacent domain other than the foregoing adjacent domain. In so doing, the route calculation unit 102 sets the own domain ID as a transit domain ID into the route information, and sets, in the route information, based on the information held by the quality management unit 101, the path specifications supported by the route of the section between the relay SLG 30 of the own domain adjacent to the advertisement destination domain and the relay SLG 30 of the notification source domain of the foregoing arrival destination domain ID, and the quality information (bandwidth, latency, etc.) of each path specification.

When the route information is advertised (notified) from the NW controller 10 of the adjacent domain, the route calculation unit 102 stores the route information in the inter-domain connection table, adds the domain ID of the own domain to the transit domain ID, updates the path specifications and the quality information as necessary on the basis of the information held by the quality management unit 101, and then advertises the route information to the NW controller 10 of an adjacent domain other than the foregoing adjacent domain.

The route calculation unit 102 holds an inter-domain connection table, and sets a transfer table for the edge SLG 20 and the relay SLG 30 of the own domain on the basis of route information stored in this inter-domain connection table.

As shown in FIG. 10, the edge SLG 20 according to the present embodiment includes a header setting unit 201 and a transfer processing unit 202. These function units are realized by hardware such as a processor or a memory device.

On the basis of a 5-tuple information (transmission source IP address, transmission destination IP address, transmission source port number, transmission destination port number, protocol number), input I/F information, and the like of a packet input from a slice end point, the header setting unit 201 identifies a slice to which the packet belongs. Then, on the basis of the identification result, the header setting unit 201 gives the packet slice requirements, the domain ID of the transmission destination, and the slice identification information, as a slice exclusive header. In the present embodiment, when the header setting unit 201 gives a slice exclusive header to a packet, it is assumed that the slice requirements, the domain ID of the transmission destination, and the slice identification information are known.

The header setting unit 201 refers to the slice identification information of the slice exclusive header given to the packet input from the relay SLG 30, and thereafter deletes this slice exclusive header and then outputs the packet to an appropriate slice end point.

The transfer processing unit 202 holds a transfer table, refers to this transfer table, determines an output destination tunnel matching a transmission destination domain ID and transfer requirements included in a slice exclusive header of a packet, and outputs the packet to the output destination tunnel.

As shown in FIG. 10, the relay SLG 30 according to the present embodiment includes a transfer processing unit 301. This function unit is realized by hardware such as a processor or a memory device.

The transfer processing unit 301 holds a transfer table, refers to this transfer table, determines an output destination tunnel matching a transmission destination domain ID and transfer requirements included in a slice exclusive header of a packet, and outputs the packet to the output destination tunnel.

When the transmission destination domain ID included in the slice exclusive header of the packet is the own domain ID, the transfer processing unit 301 specifies an edge SLG 20 to which the packet should reach, on the basis of slice identification information included in the slice exclusive header, 5-tuple information included in the header of the packet, and the like. Then, the transfer processing unit 301 outputs the packet to the specified edge SLG 20 by using a path that satisfies transfer requirements included in this slice exclusive header. It is assumed that the conditions for specifying the edge SLG 20 are set by, for example, the NW controller 10 or the like, and are known in the present embodiment.

### Example

Hereinafter, S51 to S54 of the route learning processing and S41 to S44 of the transfer processing will be described by using the above-mentioned function units.

### Route Learning Processing

S51) The route calculation unit 102 of the NW controller 10 of each domain advertises (notifies) the domain ID of the own domain to an NW controller of an adjacent domain as an arrival destination domain ID.

S52) When the arrival destination domain ID is notified from the NW controller 10 of the adjacent domain, the route calculation unit 102 of each NW controller 10 advertises route information to the NW controller 10 of an adjacent domain other than this adjacent domain. The route information includes the arrival destination domain ID, the transit domain ID indicating the domain ID of the own domain, path specifications supported by the route of the section between the relay SLG of the own domain adjacent to the advertisement destination domain and the relay SLG of the notification source domain of the arrival destination domain ID, and quality information of each path specification (e.g., bandwidth, latency, etc). Among them, the path specifications and the quality information for each path specification use information held by the quality management unit 101 of the NW controller 10 that advertises the route information.

S53) When the route information is notified from the NW controller 10 of the adjacent domain, the route calculation unit 102 of each NW controller 10 stores the route information in the inter-domain connection table, adds the domain ID of the own domain to the transit domain ID, updates the path specifications and quality information as necessary, and advertises the route information to the NW controller 10 of an adjacent domain other than the foregoing adjacent domain.

In this case, the path specifications and the quality information are updated by (A) to (C) described above by using the path specifications and the quality information held by the quality management unit 101 of the NW controller 10 that advertises the route information and the path specifications and the quality information included in the notified route information.

In S53, the route calculation unit 102 does not advertise the route information to the adjacent domain when the above-described conditions are satisfied so that a loop of the route information is not generated.

S54) The route calculation unit 102 of the NW controller 10 of each domain sets a transfer table for an edge SLG 20 and a relay SIG 30 in the own domain on the basis of the inter-domain connection table held in itself.

### Transfer Processing

S41) When a packet is input from a slice end point, the header setting unit 201 of the edge SLG 20 of each domain identifies a slice to which the packet belongs, on the basis of 5-tuple information, input I/F information, and the like of the packet. Then, the header setting unit 201 adds (gives) a slice exclusive header to the packet on the basis of the identification result.

S42) Upon reception of a packet transferred from the other relay SLG 30, the transfer processing unit 301 of each relay SLG 30 of each domain other than the transmission destination domain refers to the transfer table set in itself, determines an appropriate output destination tunnel from the slice exclusive header of the packet, and transfers the packet.

S43) Upon reception of a packet transferred from the other relay SLG 30, the transfer processing unit 301 of each relay SLG 30 of the transmission destination domain transfers the packet to a corresponding edge SLG 20 of the own domain on the basis of slice identification information included in the slice exclusive header of the packet and 5-tuple information included in a header of the packet.

S44) Upon reception of a packet transferred from a relay SLG 30, the transfer processing unit 202 of the edge SLG 20 refers to slice identification information included in the slice exclusive header of the packet, deletes this slice exclusive header, and outputs this packet to an appropriate slice end point.

### Hardware Configuration

Finally, hardware configurations of the NW controller 10, the edge SLG 20, and the relay SLG 30 according to the present embodiment will be described.

### NW Controller 10

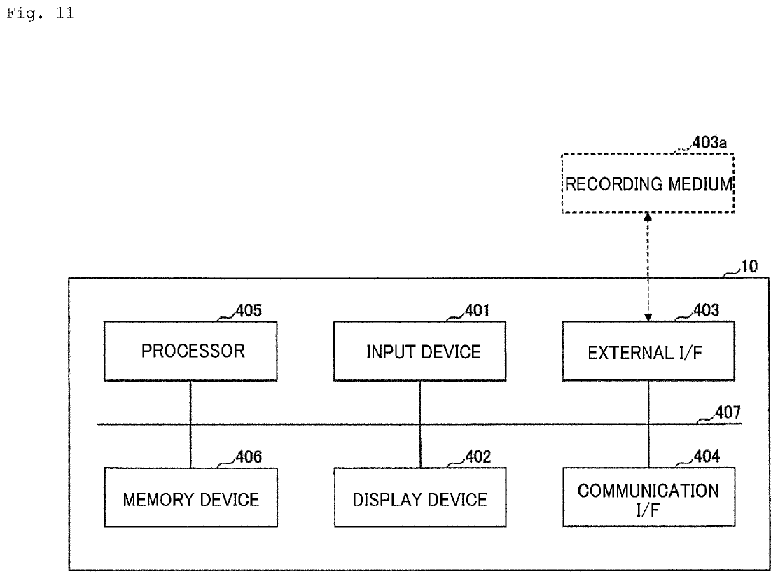

As shown in FIG. 11, the NW controller 10 according to the present embodiment includes an input device 401, a display device 402, an external I/F 403, a communication I/F 404, a processor 405, and a memory device 406. These hardware components are connected via a bus 407 so as to be able to communicate with each other.

The input device 401 is, for example, a keyboard, a mouse, a touch panel, or the like. The display device 402 is, for example, a display or the like. Note that the NW controller 10 may not include at least one of the input device 401 and the display device 402.

The external I/F 403 is an interface with an external device, such as a recording medium 403a. Examples of the recording medium 403a include a CD (Compact Disc), a DVD (Digital Versatile Disc), an SD memory card (Secure Digital memory card), and a USB (Universal Serial Bus) memory card.

The communication I/F 404 is an interface for connecting to a communication network. The processor 405 is an arithmetic device such as a CPU (Central Processing Unit). The memory device 406 is one of various storage devices such as a HDD (Hard Disk Drive), a SSD (Solid State Drive), a RAM (Random Access Memory), a ROM (Read Only Memory), and a flash memory.

The NW controller 10 according to the present embodiment can implement various types of processing described above by having the hardware configuration illustrated in FIG. 11. Note that the hardware configuration shown in FIG. 11 is an example, and the NW controller 10 may have another hardware configuration. For example, the NW controller 10 may also include a plurality of processors 405, and may also include a plurality of memory devices 406.

### Edge SLG 20 and Relay SLG 30

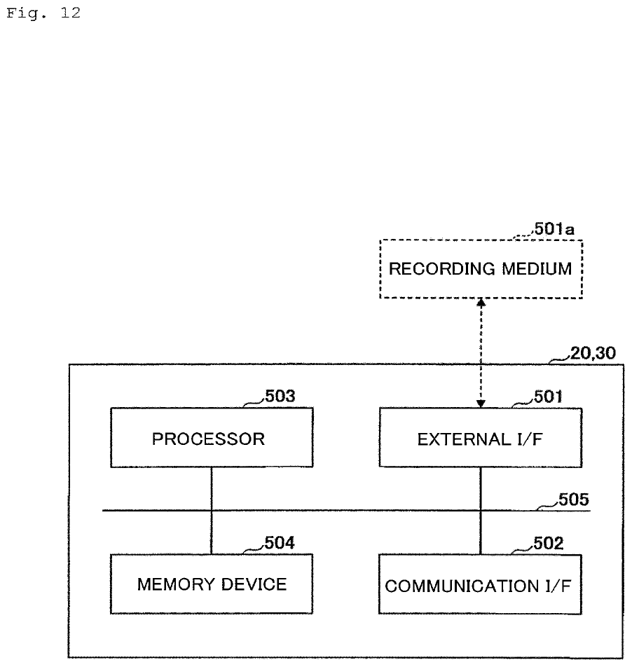

As shown in FIG. 12, the edge SLG 20 and the relay SLG 30 according to the present embodiment include an external I/F 501, communication I/F 502, a processor 503, and a memory device 504. These hardware components are connected via a bus 505 so as to be able to communicate with each other.

The external I/F 501 is an interface with an external device, such as a recording medium 501a. The recording medium 501a is, for example, a micro SD, a USB memory card, or the like.

The communication I/F 502 is an interface for connecting to a communication network N. The processor 503 is an arithmetic device such as a CPU. The memory device 504 is, for example, one of various storage devices such as a flash memory, a RAM, and a ROM.

The edge SLG 20 and the relay SLG 30 according to the present embodiment can implement various types of processing described above by having the hardware configuration illustrated in FIG. 12. Note that the hardware configuration shown in FIG. 12 is an example, and the edge SLG 20 and the relay SLG 30 may have another hardware configuration. For example, the edge SLG 20 and the relay SLG 30 may include a plurality of processors 503 and may include a plurality of memory devices 504.

The present invention is not limited to the foregoing embodiments that are specifically disclosed, and various modifications and changes, combinations with known techniques, and the like are possible without departing from the description of the claims.

### REFERENCE SIGNS LIST

10 NW controller
20 Edge SLG
30 Relay SLG
101 Quality management unit
102 Route calculation unit
201 Header setting unit
202 Transfer processing unit
301 Transfer processing unit
401 Input device
402 Display device
403 External I/F
403a Recording medium
404 Communication I/F
405 Processor
406 Memory device
407 Bus
501 External I/F
501a Recording medium
502 Communication I/F
503 Processor
504 Memory device
505 Bus

1. A gateway device, comprising:
a memory; and
a processor configured to execute:
referring to a transfer table for determining a transfer destination tunnel of a packet upon reception of the packet provided with a header including a slice requirement indicating a packet transfer requirement and a transmission destination domain ID indicating a domain of a transmission destination of the packet, to specify a tunnel corresponding to the slice requirement and the transmission destination domain ID; and
outputting the packet to the tunnel specified by the referring.

2. The gateway device according to claim 1, wherein the header further includes identification information for identifying the slice, when the transmission destination domain ID is not a domain ID of a domain to which the gateway device belongs, the referring refers to the transfer table to specify a tunnel corresponding to the slice requirement and the transmission destination domain ID, and when the transmission destination domain ID is a domain ID of a domain to which the gateway device belongs, the referring specifies other gateway device that is disposed in an edge in the domain to which the gateway device belongs, based on at least one of the identification information and 5-tuple information of the packet, and specifies a tunnel that satisfies the slice requirement, the tunnel being a tunnel for transferring the packet to the specified other gateway device.

3. A network control device, comprising:
a memory; and
a processor configured to execute:
managing route types of routes between predetermined sections and quality information for each route type;
exchanging route information with other network control device connected via a communication network, the route information including a transmission destination domain ID and a transit domain ID of a route of an E2E, a route type of the route, and quality information of the route; and
setting a transfer table for transmitting a packet to a domain of the transmission destination domain ID, for a gateway device of an own domain by using the route information exchanged by the exchanging.

4. The network control device according to claim 3, wherein the exchanging compares the route types and the quality information for each of the route types managed by the managing with the route types and the quality information for each of the route types included in the route information, updates the route information when a predetermined condition is satisfied, and transmits the updated route information to other network control device to exchange the route information.

5. A method executed by a computer, the method comprising:
referring to a transfer table for determining a transfer destination tunnel of a packet upon reception of the packet provided with a header including a slice requirement indicating a packet transfer requirement and a transmission destination domain ID indicating a domain of a transmission destination of the packet, to specify a tunnel corresponding to the slice requirement and the transmission destination domain ID; and
outputting the packet to the tunnel specified by the transfer destination specification procedure.

6. (canceled)

7. A non-transitory computer-readable recording medium having computer-readable instructions stored thereon, which when executed, cause a computer to function as the gateway device according to claim 1.

8. (canceled)

9. A non-transitory computer-readable recording medium having computer-readable instructions stored thereon, which when executed, cause a computer to function as the network control device according to claim 3.
